(19) United States
(12) Patent Application Publication
(10) Pub. No.: US 2014/0187337 A1
(43) Pub. Date: Jul. 3, 2014

(54) TRIPOD JOINT

(71) Applicants: Hyndai WIA Corporation, Changwon (KR); Hyundai Motor Company, Seoul (KR)

(72) Inventors: Min Kyu Kim, Hwaseong (KR); Hyo Seok Kim, Gwangmyeong (KR); Hyang Cheol Jo, Suwon (KR); Pil Ki Kim, Gunpo (KR)

(73) Assignees: HYUNDAI WIA CORPORATION, Changwon (KR); HYUNDAI MOTOR COMPANY, Seoul (KR)

(21) Appl. No.: 13/896,597

(22) Filed: May 17, 2013

(30) Foreign Application Priority Data
Dec. 28, 2012 (KR) 10-2012-0156079

(51) Int. Cl. F16D 3/223

(52) U.S. Cl. CPC F16D 3/223
USPC 464/111

(57) ABSTRACT

The present invention discloses a tripod joint including: a housing having one or more radially positioned track grooves; a spider having one or more radially positioned trunnions protruding from the outer circumferential surface of the spider, the one or more radially positioned trunnions disposed within the one or more radially positioned track grooves of the housing, wherein the spider is configured to move in the axial direction of the housing one or more rollers disposed on the one or more radially positioned trunnions, the one or more rollers in contact with the inner circumferential surface of the one or more track grooves of the housing; and a lubricating mechanism configured to supply oil to the trunnions and the rollers.

### CROSS-REFERENCE TO RELATED APPLICATION

This application claims under 35 U.S.C. §119(a) the benefit of Korean Patent Application No. 10-2012-0156079, filed on Dec. 28, 2012 in the Korean Intellectual Property Office, the disclosure of which is incorporated herein in its entirety by reference.

### BACKGROUND

(a) Technical Field

The present invention relates to a tripod joint. More particularly, the present invention relates to a tripod joint in which lubrication performance is improved by forming grooves, through which oil passes, at the contact portions between trunnions and spherical rollers.

(b) Background Art

In general, a vehicle drive shaft transmits power generated from a power train to the wheels of the vehicle. Typically, a vehicle drive shaft is equipped with joints (e.g., a tripod joint) on the transmission and/or wheel ends of the drive shaft, which allows power from the power train to be transmitted non-linearly. For example, the power may be transmitted through angled bends in the drive shaft.

FIG. 1 shows the structure of a conventional tripod joint, which includes a housing 1, a spider 2, spherical rollers 3, needle rollers 4, striker outs 5, and circle clips 6. Additionally, trunnions 2a radially protrude from the spider 2, the needle rollers 4 are fitted on the trunnions 2a, and the spherical rollers 3 are fitted on the needle rollers 4. The outer circumferential surface of the trunnions 2a and the outer and inner circumferential surfaces of the spherical rollers 3 may be ground.

On the other hand, FIG. 2 shows the structure of a low-cost tripod joint based on the structure of the tripod joint shown in FIG. 1, in which the needle rollers and the striker outs are removed, the grinding of parts is eliminated, and lathe turning and forging are applied to trunnions 20 and spherical rollers 30. However, since needle rollers are not provided and grinding is not performed in the tripod joint shown in FIG. 2, the friction force between the internal parts increases. Unfortunately, this decreases the durability of the parts, and increases both idle vibration and axial vibration in a vehicle, thereby deteriorating the noise, vibration, and harshness (NVH) of the vehicle. While some conventional solutions address this problem by mounting a needle bearing in the tripod joint, this is very difficult to implement without significantly increasing the cost of production of the resulting tripod joint.

Furthermore, it should be noted that the description provided above is merely for aiding in understanding the background of the present invention, and should not be construed as admitted prior art.

### SUMMARY OF THE DISCLOSURE

The present invention has been made in an effort to solve the problems of the conventional art and it is an object of the present invention to provide a tripod joint having improved lubrication performance by forming grooves, through which oil passes, at the contact portions between the trunnions and rollers. Another object of the present invention is to provide a tripod joint having improved lubrication performance without deteriorating the durability of parts by restricting the shapes of grooves through which oil flows inside.

In order to achieve the objects of the present invention, the present invention provides a tripod joint that includes: a housing having one or more radially positioned track grooves; a spider having one or more radially positioned trunnions protruding from the outer circumferential surface of the spider, the one or more radially positioned trunnions disposed within the one or more radially positioned track grooves of the housing, wherein the spider is configured to move in the axial direction of the housing; one or more rollers disposed on the one or more radially positioned trunnions, the one or more rollers in contact with the inner circumferential surface of the one or more track grooves of the housing; and a lubricating mechanism configured to supply oil to the trunnions and the rollers.

The lubricating mechanism may be implemented by forming one or more first oil grooves on the outer circumferential surface of the trunnion. The one or more first oil grooves may be formed spirally on the outer circumferential surface of the trunnion.

The lubricating mechanism may be implemented by forming one or more second oil grooves on the inner circumferential surface of the trunnion. The one or more second oil grooves may be formed spirally on the inner circumferential surface of the trunnion.

A third oil groove may be formed on the outer circumferential surface of the roller.

The pitch of the spiral oil grooves may be calculated from the following Expression 1:

PCD/(α/2)−PCD/(2×β)≦Pi≦PCD/(α/2)+PCD/(2×β) [Expression 1]

where α is the outer diameter of the roller, β is the outer diameter of the trunnion, and PCD is the diameter of a circle connecting the centers of forces applied to the rollers.

The inner radii of the spiral oil grooves may range from about 0.5 mm to about 1 mm.

### BRIEF DESCRIPTION OF THE DRAWINGS

The above and other features of the present invention will now be described in detail with reference to certain exemplary embodiments thereof illustrated by the accompanying drawings, which are given hereinbelow by way of illustration only, and thus are not limitative of the present invention, and wherein:

FIG. 1 is a view showing the structure of a tripod joint according to the conventional art;

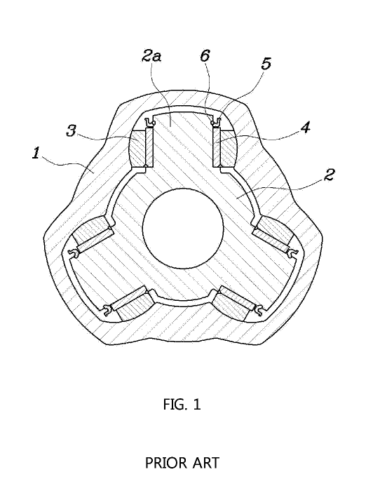

FIG. 2 is a view showing the structure of another tripod joint according to the conventional art;

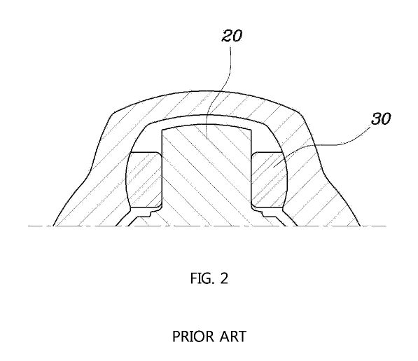

FIG. 3 is a view showing the structure of a tripod joint according to an exemplary embodiment of the present invention;

FIG. 4 is a view showing the shape of the one or more oil grooves formed on a trunnion according to an exemplary embodiment of the present invention;

FIG. 5 is a view showing the shape of the one or more oil grooves formed on a roller according to an exemplary embodiment of the present invention;

FIG. 6 is a diagram showing the result of testing axial vibration through tripod joints according to an exemplary embodiment of the present invention and the conventional art; and

FIG. 7 is a diagram showing the result of testing vibration in idling through tripod joints according to an exemplary embodiment of the present invention and the related art.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Exemplary embodiments of the present invention are described hereafter in detail with reference to the accompanying drawings.

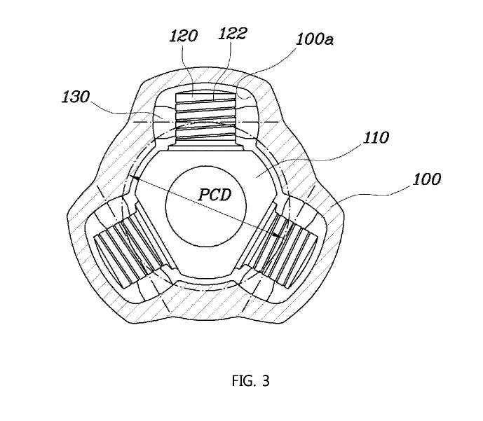

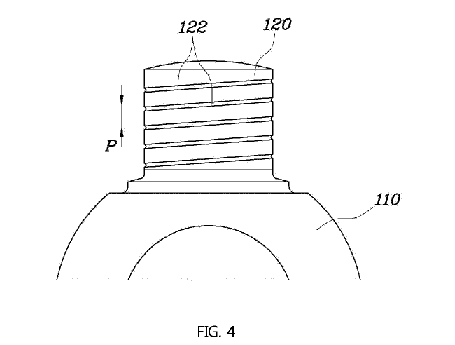

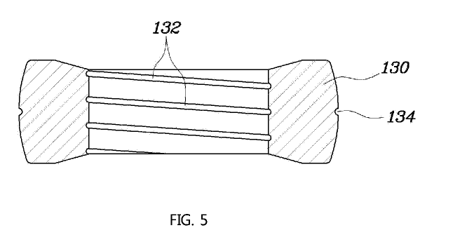

FIG. 3 is a view showing the structure of a tripod joint according to an exemplary embodiment of the present invention. FIG. 4 is a view showing the shape of oil grooves formed on a trunnion 120 according to the present invention. FIG. 5 is a view showing the shape of oil grooves formed on a roller according to the present invention.

A tripod joint of the present invention may include a housing 100, a spider 110, one or more trunnions 120, one or more rollers 130, and a lubricating mechanism. The configuration of the tripod joint according to the present invention is described in detail with reference to FIG. 3. The tripod joint may include: a housing 100 having one or more radially positioned track grooves 100a, a spider 110 disposed in the housing 100, and configured to move in the axial direction of the housing 100. The spider may include one or more radially positioned trunnions 120 protruding from the spider 110. Preferably, the spider may include three radially positioned trunnions 120. Trunnions 120 may be fitted with rollers in contact with the inner circumferential surface of the housing, and may include one or more grooves at the contact portions between the trunnions and the rollers that form a lubricating mechanism such that oil is supplied to the rollers and the trunnions (e.g., to the contact portions therebetween).

In more detail, for the configuration described above, first, the spider 110 may be disposed in the housing 100 and configured to move in the axial direction of the housing 100. Three track grooves 100a may be formed on the inner circumferential surface of the housing 100 radially with respect to the axis of the housing 100. The trunnions 120 radially protruding from the spider 110 are positioned to correspond to the track grooves 100a and to be guided by the track grooves 110a, so that the spider 110 can move in the axial direction of the housing 100.

The rollers 130 are fitted on the trunnions 120 such that the inner circumferential surfaces may come into contact with the outer circumferential surfaces of the trunnions 120, and the outer circumferential surfaces may come into contact with the inner circumferential surface of the housing 100, so the rollers may make a bent-angle movement (e.g., allowing transmission of power from the drive train in a non-linear manner) by vertically moving about the axes of the trunnions 120.

Referring to FIG. 4, a lubricating mechanism may be implemented by forming one or more first oil grooves 122 on the outer circumferential surface of the trunnion 120, such that the one or more grooves may be located at the contact portions between the trunnions 120 and the rollers 130 so that oil may be supplied therebetween.

In detail, the one or more first oil grooves 122 may be formed spirally on the outer circumferential surface of the trunnion 120. The first oil grooves 122 may have a predetermined radius and be formed spirally on the outer circumferential surface of the trunnion 120, such that oil flows onto the contact surface between the trunnion 120 and the roller 130.

Referring to FIG. 5, the lubricating mechanism may be implemented by forming one or more second oil grooves 132 on the inner circumferential surface of the roller 130. In detail, the second oil grooves 132 may be formed spirally on the inner circumferential surface of the roller 130. The second oil grooves 132 may have a predetermined radius and be formed spirally on the inner circumferential surface of the trunnion 120, such that oil flows onto the contact surface between the trunnion 120 and the roller 130.

Since the first oil grooves 122 and the second oil grooves 132 may be spirally formed, the lengths of pitches P can be calculated and restricted by the following Expression 1.

PCD/(α/2)−PCD/(2×β)≦Pi≦PCD/(α/2)+PCD/(2×β). [Expression 1]

Where α is the outer diameter of the roller 130, β is the outer diameter of the trunnion 120, and PCD is the diameter of a circle connecting the centers of the forces applied to the rollers.

That is, PCD/α, the length rate between the outer diameter of the roller 130 and PCD, may be constant for each size of tripod joints and PCD/β, the length rate between the outer diameter of the trunnion 120 and PCD, may be equivalent in each size of tripod joints.

The pitches P calculated from Expression 1 may range from about 1.6 to about 3.5 mm.

Advantageously, restricting the pitches P between the oil grooves may increase durability of the tripod joint by maintaining the contact stress between the rollers 130 and the trunnions 120 at 3500 Mpa or less to the yield strength torque. However, as the contact area decreases with a decrease in pitch P, the contact stress exerted in the contact area increases and the durability decreases, thus restricting the pitches P, which can increase the lubrication performance without deteriorating the durability.

The inner radii of the first oil grooves 122 and the second oil grooves 132 may range from about 0.5 to about 1 mm. The reason for restricting the inner diameters of the oil grooves, as described above, is because when the radii of the oil grooves are large, the contact surface between the roller 130 and the trunnion 120 decreases, so that the contact stress exerted in the contact area increases and durability decreases, whereas when the radii of the oil grooves are small, grease or oil for lubricating cannot smoothly flow into the oil grooves, thereby the roller 130 cannot smoothly rotate and the lubrication performance and the durability are deteriorated. Therefore, there is a necessity to restrict the shapes of the oil grooves in order to increase the lubrication performance without deteriorating the durability of the parts.

Further, a third oil groove 134 may be formed on the outer circumferential surface of the roller 130. That is, the third oil groove 134 having a predetermined diameter may be formed along the center of the outer circumferential surface of the roller 130, such that oil flows onto the contact surface between the roller 130 and the housing 100.

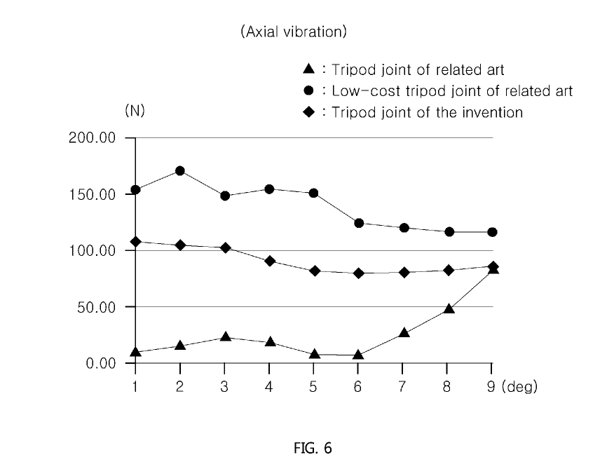

FIG. 6 is a diagram showing the results of testing axial vibration through tripod joints according to the present invention and the related art, in which the y axis shows axial force applied to the housing 100 and the x axis indicates degree of vibration. It can be seen from FIG. 6 that there is an effect of reducing axial vibration by about 40-50%, when oil grooves are formed on the rollers 130 and the trunnions 120, in comparison with the structures of the tripod joint without oil grooves in the conventional art. In other words, the axial force applied to the housing 100 is proportionate to vibration, so that the degree of vibration can be known. Therefore, as shown in FIG. 6, the tripod joint of the present invention considerably reduces the axial force, as compared with low-cost tripod joints of the related art and even using a tripod joint with price competitiveness.

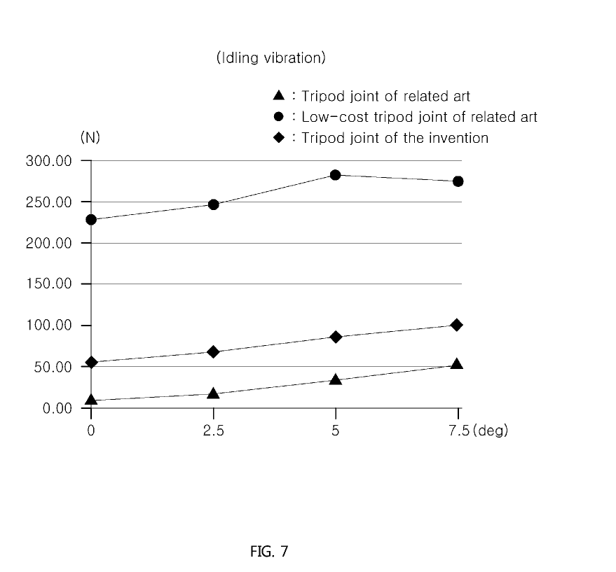

FIG. 7 is a diagram showing the result of testing idling vibration through tripod joints according to the present invention and the related art. It can be seen from FIG. 7 that idling vibration was reduced to about ⅕, and idling vibration performance was improved even close to the levels of common tripod joints, when oil grooves are formed on the rollers 130 and the trunnions 120, as compared with tripod joints without oil grooves in the conventional art.

That is, as described above, the axial force on y axis is considerably reduced in the tripod joint of the present invention, compared with low-cost tripod joints of the related art, therefore the idling vibration of the tripod joint is reduced, even using a tripod joint with price competitiveness.

As described above, as oil grooves are formed in the contact portions between the trunnions 120 and the rollers 130, the lubrication performance of parts is improved and the axial and idling vibration performance is improved as well with the improvement of the lubrication performance.

Further, the present invention improves the lubrication performance of parts by restricting the shape and structure of the oil grooves so that the durability of the parts does not deteriorate.

Therefore, the present invention improves lubrication performance of parts by forming oil grooves at the contact portions between trunnions and rollers and improves axial and idling vibration performance as well with the improvement of the lubrication performance. Further, the present invention improves the lubrication performance of parts by restricting the shape and structure of the oil grooves without deteriorating the durability of the parts.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A tripod joint, comprising:
a housing having one or more radially positioned track grooves;
a spider having one or more radially positioned trunnions protruding from the outer circumferential surface of the spider, the one or more radially positioned trunnions disposed within the one or more radially positioned track grooves of the housing, wherein the spider is configured to move in the axial direction of the housing;
one or more rollers disposed on the one or more radially positioned trunnions, the one or more rollers in contact with the inner circumferential surface of the one or more track grooves of the housing; and
a lubricating mechanism configured to supply oil to the trunnions and the rollers.

2. The tripod joint of claim 1, wherein the lubricating mechanism includes one or more first oil grooves disposed on an outer circumferential surface of the one or more trunnions.

3. The tripod joint of claim 2, wherein the one or more first oil grooves are formed spirally on the outer circumferential surface of the trunnion.

4. The tripod joint of claim 1, wherein the lubricating mechanism includes one or more second oil grooves disposed on an inner circumferential surface of the one or more rollers.

5. The tripod joint of claim 4, wherein the one or more second oil grooves are formed spirally on the inner circumferential surface of the roller.

6. The tripod joint of claim 1, wherein a third oil groove is formed on the outer circumferential surface of the roller.

7. The tripod joint of claim 2, wherein the pitch of the spiral oil grooves is calculated from the following Expression 1,
PCD/(α/2)−PCD/(2×β)≦Pi≦PCD/(α/2)+PCD/(2×β) [Expression 1]
where α is the outer diameter of the roller, β is the outer diameter of the trunnion, and PCD is the diameter of a circle connecting the centers of forces applied to the rollers.

8. The tripod joint of claim 4, wherein the pitch of the spiral oil grooves is calculated from the following Expression 1,
PCD/(α/2)−PCD/(2×β)≦Pi≦PCD/(α/2)+PCD/(2×β) [Expression 1]
where α is the outer diameter of the roller, β is the outer diameter of the trunnion, and PCD is the diameter of a circle connecting the centers of forces applied to the rollers.

9. The tripod joint of claim 2, wherein the inner radii of the spiral oil grooves range from about 0.5 to about 1 mm.

10. The tripod joint of claim 4, wherein the inner radii of the spiral oil grooves range from about 0.5 to about 1 mm.
